(19) United States
(12) Patent Application Publication
(10) Pub. No.: US 2025/0147749 A1
(43) Pub. Date: May 8, 2025

(54) UPDATE MANAGEMENT SYSTEM

(71) Applicant: HITACHI ASTEMO, LTD., Hitachinaka-shi, Ibaraki (JP)

(72) Inventors: Tatsuaki NAGAI, Chiyoda-ku, Tokyo (JP); Hideyuki SAKAMOTO, Chiyoda-ku, Tokyo (JP); Yuji FUKUSHIMA, Chiyoda-ku, Tokyo (JP); Tsutomu KANEKO, Chiyoda-ku, Tokyo (JP); Takaaki NOKAIDO, Chiyoda-ku, Tokyo (JP)

(73) Assignee: HITACHI ASTEMO, LTD., Hitachinaka-shi, Ibaraki (JP)

(21) Appl. No.: 18/836,908

(22) PCT Filed: Aug. 24, 2022
(86) PCT No.: PCT/JP2022/031917

§ 371 Date: Aug. 8, 2024

(30) Foreign Application Priority Data
Mar. 1, 2022 (JP) 2022-030676

(51) Int. Cl. G06F 8/65

(52) U.S. Cl. CPC G06F 8/65

(57) ABSTRACT

An object of the present invention is to obtain an update management system that makes it possible to perform writing and switching of a program in an ECU configuration having redundancy while a vehicle is traveling, even when the ECU configuration does not have a double-sided memory structure. An update management system of the present invention is mounted on a vehicle and includes: a plurality of arithmetic operation devices; and an update management device that controls the plurality of arithmetic operation devices. The plurality of arithmetic operation devices include at least a first arithmetic operation device and a second arithmetic operation device. The update management device determines whether the second arithmetic operation device is executing a redundant process while the vehicle is traveling, and when determining that the second arithmetic operation device is not executing the redundant process, the update management device restricts execution of the redundant process by the first arithmetic operation device and updates a program stored in the second arithmetic operation device.

### TECHNICAL FIELD

The present invention relates to a program update technique for an electronic control unit (ECU) mounted on a vehicle.

### BACKGROUND ART

Regarding autonomous driving technologies of an automobile, an ECU and a sensor system are required to have redundancy to ensure safety. Specifically, it is required to secure functional safety by preparing, for example, two ECUs having the same function and causing one ECU to exhibit the function when the other ECU is urgently stopped.

In a case where a running program is switched in this manner, it is required to suppress a running system from being affected. Regarding such a technique, PTL 1 describes that “The operation verification and switching unit prepares, as a substitute program, a control program for the same execution environment as the control program to be updated”.

### CITATION LIST

### Patent Literature

PTL 1: WO 2015/037116 A

### SUMMARY OF INVENTION

### Technical Problem

In recent years, programs installed in on-board ECUs are often updated by using over the air (OTA) technology. In the conventional technology related to update of a program of an ECU by using the OTA, a double-sided memory structure is required to write a new program while a vehicle is traveling (while an ECU program is running), and it is impossible to switch to the new program while the current program is running. In other words, for example, in order to make redundant an ECU configuration having two ECUs, one ECU (ECU_1) needs to constantly monitor an operation state of program of the other ECU (ECU_2); therefore, a program being executed by the ECU_2 cannot be updated. Therefore, in order to update the program stored in the ECU_2, a double-sided memory structure needs to be formed such that a storage area having the same capacity as a program storage area storing the program being executed by the ECU_2 is separately mounted, and switching needs to be performed after the program stored in the separately mounted storage area is updated.

An object of the present invention is to make it possible to perform writing and switching of a program in an ECU configuration having redundancy while a vehicle is traveling, even when the ECU configuration does not have a double-sided memory structure.

### Solution to Problem

An update management system according to an embodiment of the present invention is mounted on a vehicle and includes: a plurality of arithmetic operation devices; and an update management device that controls the plurality of arithmetic operation devices. The plurality of arithmetic operation devices include at least a first arithmetic operation device and a second arithmetic operation device. The update management device determines whether the second arithmetic operation device is executing a redundant process while the vehicle is traveling, and when determining that the second arithmetic operation device is not executing the redundant process, the update management device restricts execution of the redundant process by the first arithmetic operation device and updates a program stored in the second arithmetic operation device.

### Advantageous Effects of Invention

With the present invention, it is possible to update and switch a program in an ECU having a redundant configuration while a vehicle is traveling, with minimum memory resources.

Additional features related to the present invention will become apparent from the description of the present specification and the accompanying drawings. In addition, problems, configurations, and effects other than those described above will be clarified by the following description of embodiments.

### BRIEF DESCRIPTION OF DRAWINGS

FIG. 1 is a block diagram illustrating a configuration of an update management system according to an embodiment of the present invention.

FIG. 2 is a flowchart illustrating an example of a program update process.

FIG. 3 is a flowchart illustrating another example of the program update process.

FIG. 4 is a sequence diagram illustrating an example of the process from a synchronization process to a switching process.

FIG. 5 is a block diagram illustrating a configuration of an update management system according to another embodiment of the present invention.

### DESCRIPTION OF EMBODIMENTS

Hereinafter, embodiments will be described with reference to the drawings.

### First Embodiment

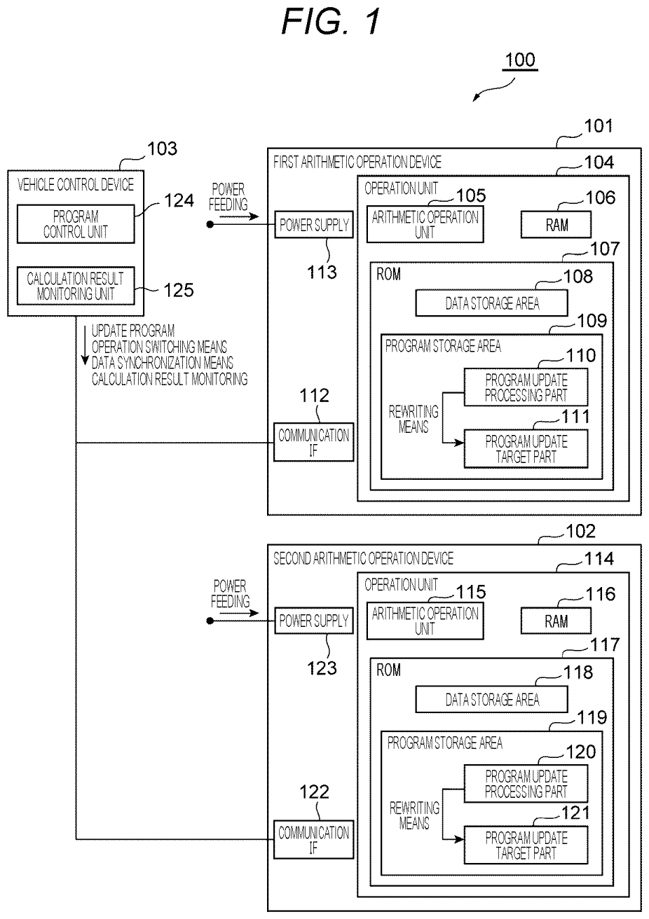

FIG. 1 is a block diagram illustrating an overall configuration of an update management system according to a first embodiment of the present invention. An update management system 100 includes: a first arithmetic operation device 101 and a second arithmetic operation device 102; and a vehicle control device 103 that controls these arithmetic operation devices. The first arithmetic operation device 101, the second arithmetic operation device 102, and the vehicle control device 103 are ECUs that are mounted on, for example, a vehicle and exhibit various functions and that are connected to each other via a communication network such as a controller area network (CAN). Note that the above devices may be separately mounted in the vehicle, or may be configured to have a zone architecture in which the devices are collectively mounted in one ECU.

A configuration of the first arithmetic operation device 101 will be described. In the present embodiment, the first arithmetic operation device 101 and the second arithmetic operation device 102 have the same configuration and function. Therefore, description about the second arithmetic operation device 102 is omitted. The first arithmetic operation device 101 includes an operation unit 104, a communication interface (IF) 112, and a power supply 113. The operation unit 104 implements various functions by executing a stored program. The communication IF 112 transmits and receives various types of data to and from the second arithmetic operation device 102 and the vehicle control device 103 via the network. The power supply 113 stores electric power supplied from an external power supply and functions as a power supply.

The operation unit 104 is configured with a central processing unit (CPU) and includes: an arithmetic operation unit 105 that executes a program; a random access memory (RAM) 106 in which data can be written and from which data can be read out; and a ROM 107 from which data can be read out. The ROM 107 is, for example, a nonvolatile memory. The ROM 107 further includes a data storage area 108 for storing control data and a program storage area 109 for storing an execution program. A program stored in a program update target part 111 of the program storage area 109 is rewritten and updated by a rewriting unit included in a program update processing part 110.

The vehicle control device 103 includes a program control unit 124 and a calculation result monitoring unit 125. The program control unit 124 switches operation states (redundant process, control value output, synchronization process, and the like) of the arithmetic operation devices. The calculation result monitoring unit 125 monitors a calculation result of each arithmetic operation device and determines, for example, whether a redundant process is accurately performed. In addition, the vehicle control device 103 receives, from an external server or the like, an update program and information regarding whether the program stored in each arithmetic operation device needs to be updated, and transmits the update program to each arithmetic operation device. That is, the vehicle control device 103 functions as the update management device in the present embodiment.

Here, the redundant process in the present invention is a process performed by a system having two or more systems of the same or substitutable different hardware and software, and the redundant system refers to the following processes, for example: a process in which different systems mutually monitor arithmetic operations of vehicle control; and a process in which, when one system fails, another system substitutes the failed system. A description will be given in the present embodiment assuming that the first arithmetic operation device 101 and the second arithmetic operation device 102 have the same functional configuration as described above. However, as long as at least a part of each functional configuration can be replaced with each other, the first arithmetic operation device and the second arithmetic operation device may be constituted by different hardware and software using different OSs or compilers.

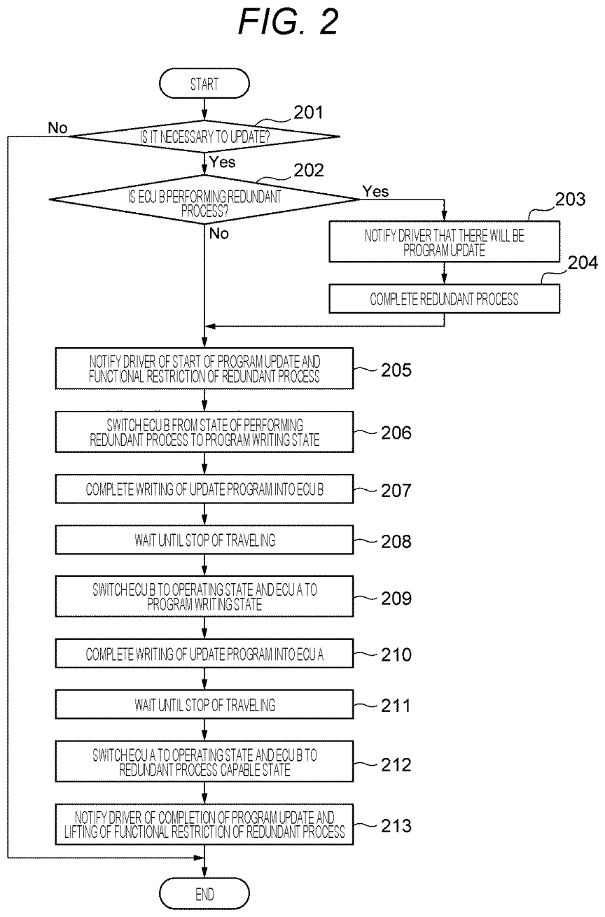

FIG. 2 is a flowchart illustrated by a process performed by the update management system 100 according to the present embodiment. In the present embodiment, the first arithmetic operation device 101 is written as the ECU_A, and the second arithmetic operation device 102 is written as the ECU_B. First, the vehicle control device 103 determines whether it is necessary to update programs stored in the ECU_A and the ECU_B (step 201). The determination can be made based on, for example, whether the program control unit 124 in the vehicle control device 103 has received update information from the outside.

When the vehicle control device 103 has determined that the update is necessary or has received an update command, the vehicle control device 103 determines whether the ECU_B is performing the redundant process (step 202). When it is determined that the redundant process is being performed, the driver is notified that there will be program update, and the process waits until the redundant process is ended (steps 203 and 204).

When it is determined in step 202 that the ECU_B is not performing the redundant process, the program control unit 124 restricts the ECU_A to perform functions that use the redundant process. That is, the program control unit 124 stops performing all the functions related to the redundant process. Then, the program control unit 124 notifies the driver of start of program update and restriction of the functions using the redundant process (step 205). Then, the program control unit 124 switches the ECU_B from a state of performing the redundant process to a program writing state and starts a program update process (step 206). At this time, it may be possible to ask the driver for an approval to the start of program update before switching to the program writing state.

After the update program is completely written in the ECU_B (step 207), the vehicle control device 103 determines whether the vehicle is traveling, in other words, whether the ECU_A is continuously executing a program, and waits until stop of traveling (step 208). Note that the expression “stop of traveling” used here does not include a temporary stop due to a red light or the like, and refers to a state in which the engine or the motor is completely stopped.

When the vehicle has stopped traveling, the program control unit 124 switches the ECU_B from the program writing state to an operating state. That is, the updated program starts to be executed. Then, the program control unit 124 switches the ECU_A from an operating state to the program writing state (step 209). Note that step 209 also includes a process of setting the program control unit 124 such that the program control unit 124 causes the ECU_B to operate at the time of the next activation in a case where traveling is not resumed after waiting until traveling is stopped in step 208.

After the update program is completely written in the ECU_A (step 210), the vehicle control device 103 waits until the vehicle again stops traveling (step 211). After the vehicle is stopped, the program control unit 124 switches the ECU_A to an operating state. That is, the updated program starts to be executed. Then, the ECU_B is switched to a redundant process capable state (step 212). Note that the redundant process capable state refers to a state in which the redundant process can be started in response to reception of a redundant process start command output from the program control unit 124, and does not refer only to a state in which the redundant process is being actually performed. Finally, the program control unit 124 completes the program update process and lifts the functional restriction of the redundant process, notifies the driver of the completion and the lifting (step 213), and ends the update process.

As described above, in the present embodiment, in a case where none of the two arithmetic operation devices is performing the redundant process, the functions of the redundant process are restricted, and the program stored in one arithmetic operation device is updated. This makes it possible to update the program without providing a plurality of program storage areas in one arithmetic operation device, and the memory resources and the manufacturing cost can therefore be reduced.

### Second Embodiment

Next, an update management system according to a second embodiment of the present invention will be described. The update management system 100 according to the second embodiment has the same configuration as the update management system 100 according to the first embodiment, and the description of the configuration and the same process as the process performed in the first embodiment will be omitted.

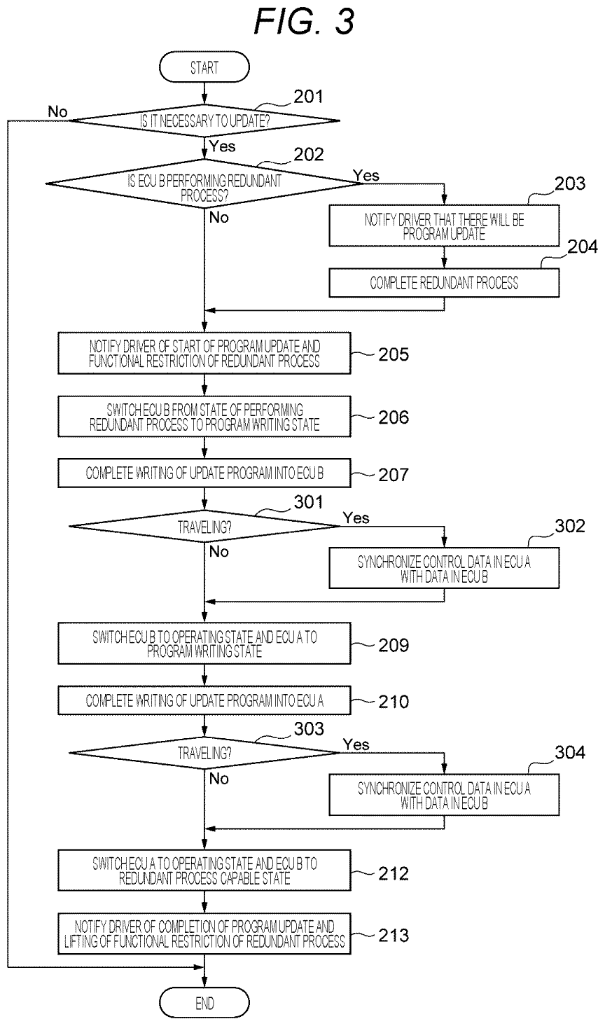

As illustrated in FIG. 3, the update management system according to the second embodiment is different in that the process illustrated in steps 301 to 304 is performed, in addition to the configuration and the process of the first embodiment. That is, after writing the update program in the ECU_B in step 207, the vehicle control device 103 determines whether the vehicle is traveling (step 301). When the vehicle is not traveling, the process proceeds to step 209 similarly to the first embodiment. When it is determined that the vehicle is traveling, the control data stored in the RAM 106 and the data storage area 108 of the ECU_A in an operating state and the control data stored in a RAM 116 and a data storage area 118 of the ECU_B are synchronized with each other (step 302). A specific method of the synchronization will be described later. Then, while the vehicle is traveling, the ECU_B is switched to an operating state and starts execution of the updated program, and ECU_A is switched to the program writing state (step 209).

When it is determined in step 303 that the vehicle is traveling, the control data stored in the RAM116 and the data storage area 118 of the ECU_B in an operating state and the control data stored in the RAM106 and the data storage area 108 of the ECU_A in the writing state are synchronized with each other (step 304). The subsequent process is the same as in the first embodiment.

The synchronization process of the control data described above will be described in detail. Regarding a redundant configuration between different ECUs, in some cases, the configuration is configured between the ECUs having different software configurations in which a part of the functional configuration can be substitute, as described above. As described above, it is necessary to perform a synchronization process between different pieces of software, and the control data used by the program before update needs to be adapted to the control data used by the new program. In order to achieve this adaptation, in the present embodiment, at least one synchronization process of the following three means is performed. Here, supposing that a′ is the control data of the ECU after update (the control data used by the updated program) and that a is the control data of the ECU before update (the control data used by the running program).
Means 1 Each piece of control data is converted to be adapted to the ECU after update (for example, a′=a+5).
Means 2 The control data of the ECU before update is stored as it is in the ECU after update (for example, a′=a).
Means 3 The ECU after update generates its own initial values (for example, a′=5).

In the means 1, in consideration of a case where the RAM value, the initial value of a variable, the data type, the data structure, and the like are different before and after the program update, substitution of the initial value, addition and subtraction of the correction value, casting of the data type, and the like in the ECU after update are performed as the synchronization process, thereby adapting the control data to the ECU after update.

In the means 2, in a case where the contents of the RAM value, the variable, and the like match before and after the program update, the values of the program before the update are substituted into the updated program. At this time, the RAM value and the variable do not necessarily coincide with each other. Even when the initial value, the data type, the data structure, and the like are different, the means 2 may be adopted when it is not necessary to consider the influence when the data before the update are substituted into the updated program.

The means 3 is a method in which the program is activated in a state where a RAM value and an initial value of a variable unique to the updated program are held and in which the data before the update is not referred to.

When any one of the above synchronization processes is performed and the operating ECUs are seamlessly switched, there is a possibility that the control values become discrete between the programs before and after the update. In a case where the program to be updated relates to, for example, steering angle control, torque control, and the like, if the control values become discrete at the timing of update, the behavior of the vehicle is greatly affected, and safety may be significantly reduced. Therefore, it is necessary to suppress such discrete transition of the control values. In order to achieve this, the following method may be proposed. While control is being performed, after the completion of the synchronization process, with the values calculated on the side of the program before the update, the control values are calculated on the updated program side, and when the control values of both programs become approximate to each other, switching is performed.

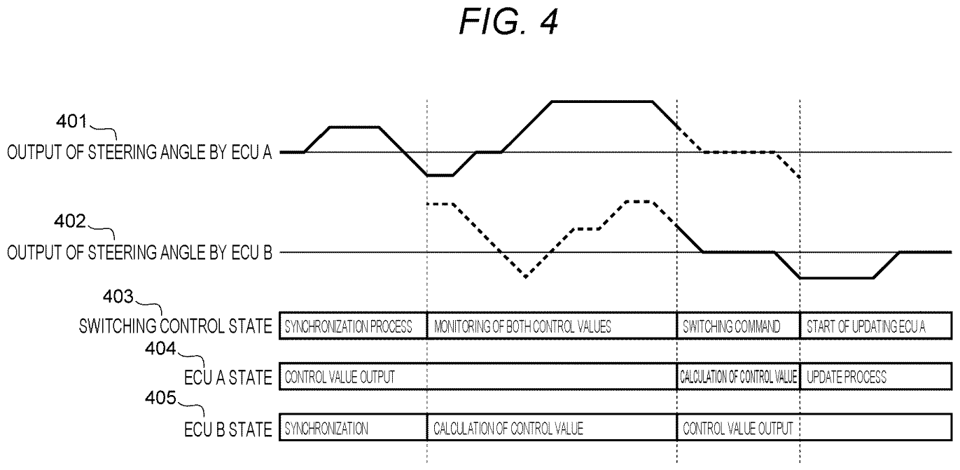

FIG. 4 is a sequence diagram illustrating an example from the synchronization process of the ECU_A and the ECU_B to the switching of the operating ECU in this method. Here, it is assumed that the ECU_A and the ECU_B respectively output a control value 401 and a control value 402 of the steering angle. A solid line represents a state where the control value related to the steering angle is output to an output destination, and a broken line represents a state in which the steering angle is calculated but is not output. When a switching control state 403 is the synchronization process, the ECU_A state 404 is a state where the steering angle is being output, and the ECU_B state 405 is a state of the synchronization process.

When the synchronization of the ECU_B has been completed, the switching control state 403 is in a state of monitoring the control values of both ECUs. That is, the state is in a state where the calculation results of both ECUs are being monitored by the calculation result monitoring unit 125. During this state, the ECU_B calculates the steering angle. At this time, the ECU_B only calculates the steering angle but does not output the steering angle to the output destination. When the degree of approximation of the steering angles of both ECUs exceeds a certain value, the program control unit 124 transmits a switching command to both ECUs, so that the ECU_A state 404 is switched to a state of calculating the steering angle, and the ECU_B state 405 is switched to a state of outputting the steering angle. After that, the process proceeds to a process of updating the ECU_A.

As described above, in the present embodiment, the control data used by the updated program is synchronized with the control data used by the program before the update in a state where the functions of the redundant process are restricted. Therefore, even when the vehicle is traveling, the program to be operated can be switched to the updated program, and convenience can be expected to be improved.

In addition, the application examples of the present embodiment include partial update of a program in the SOTA (Software Over the Air), and program update can be realized at all times, and convenience can be expected to be further improved.

### Third Embodiment

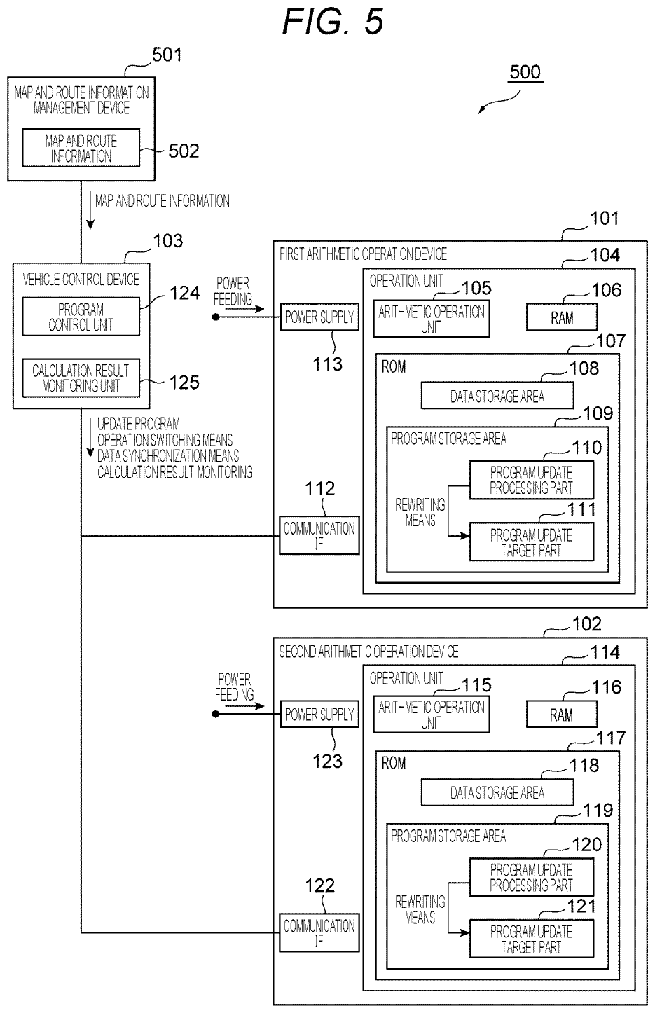

Next, an update management system according to a third embodiment of the present invention will be described. As illustrated in FIG. 5, the update management system 500 according to the third embodiment is different in that a map and route information management device 501 is included in addition to the configuration of the update management system 100 according to the first embodiment.

In the first embodiment and the second embodiment described above, the condition for starting update is whether the ECU_B is performing the redundant process when update is determined to be necessary in step 201 (step 202). In the present embodiment, it is possible to determine whether the redundant process is being performed, based on the autonomous driving level of the vehicle. In autonomous driving of Level 3 or higher, driving tasks are monitored by a system. That is, the driving entity is the system. Therefore, it is necessary to ensure the safety of the system as compared with the case where the driving entity is a human, so that the ECU related to the function of at least the autonomous driving level 3 or higher need to have a redundant configuration. Therefore, as a method for determining whether the ECU is performing the redundant process, it is possible to adopt a method of determining the autonomous driving level of the vehicle.

When determining the autonomous driving level of the vehicle, the program control unit 124 can determine whether a program for actually exerting a function of the autonomous driving level 3 or higher is being executed, but it is also possible to use map and route information 502 stored in the map and route information management device 501, as described below. Note that the map and route information management device 501 desirably has a global positioning system (GPS) function, and may be mounted in the vehicle as a car navigation system. Furthermore, the map and route information management device 501 may be configured to be mounted in the vehicle control device 103.

One of the conditions for achieving the autonomous driving level of Level 3 or higher is limitation of place. Specifically, examples include expressways, parking lots, other specific places. Therefore, by associating the information included in the map and route information 502 stored in the map and route information management device 501 with the information on the place where the autonomous driving level of Level 3 or higher can be achieved, it is possible to determine whether a place is the place to which the autonomous driving level of Level 3 or higher is applied, in other words, it is possible to determine whether a place is the place where the redundant process is executed. Specifically, the following means 4 to 6 executed by the program control unit 124 can be adopted. Note that the “autonomous driving” below means autonomous driving of the level requiring redundant process (for example, Level 3).

Means 4 The map and route information 502 by the map and route information management device 501 is used to compare an autonomous driving possible section with the position of the vehicle, and when the vehicle is out of the autonomous driving possible section or away from the autonomous driving possible section by a predetermined distance or more, the redundant process is not performed, and update is therefore determined to be possible.

Means 5 After a navigation route to a destination is generated by the driver's operation using the map and route information 502 by the map and route information management device 501, it is detected whether the navigation route passes through an autonomous driving possible section, and when the navigation route does not pass through the autonomous driving possible section, the redundant process is not performed, and update is therefore determined to be possible.

Means 6 In addition to the determination by the means 4 or 5, in a case where the estimated required time for updating the program is shorter than the estimated time to reach an autonomous driving possible section, even when the vehicle is scheduled to enter the autonomous driving possible section, the redundant process is not performed until reaching the autonomous driving possible section, and update is therefore determined to be possible.

The processes of the means 4 to 6 suppress the necessity of leaving to the driver the determination of whether the update should be performed, and convenience is therefore expected to be improved.

The embodiments of the present invention described above provide the following actions and effects.

(1) An update management system according to an embodiment of the present invention is mounted on a vehicle and includes: a plurality of arithmetic operation devices; and an update management device that controls the plurality of arithmetic operation devices. The plurality of arithmetic operation devices include at least a first arithmetic operation device and a second arithmetic operation device. The update management device determines whether the second arithmetic operation device is executing a redundant process while the vehicle is traveling, and when determining that the second arithmetic operation device is not executing the redundant process, the update management device restricts execution of the redundant process by the first arithmetic operation device and updates a program stored in the second arithmetic operation device.

With the above configuration, the program stored in the second arithmetic operation device can be updated while the first arithmetic operation device is not performing the redundant process. Therefore, it is not necessary to provide an additional 1 program storage area in the arithmetic operation device, which has been conventionally indispensable when the program is updated during the redundant process is being performed, and it is therefore possible to reduce the memory resources and the manufacturing cost.

(2) When the update management device determines, after updating the program stored in the second arithmetic operation device, that the vehicle stops, the update management device instructs the second arithmetic operation device to execute the updated program and updates a program stored in the first arithmetic operation device. As a result, also with respect to the first arithmetic operation device, the program is updated in a state where the second arithmetic operation device is not performing the redundant process, so that the memory resources and the manufacturing cost can be reduced.

(3) When the update management device determines, after updating the program stored in the first arithmetic operation device, that the vehicle stops, the update management device instructs the first arithmetic operation device to execute the updated program and lifts the restriction of execution of the redundant process by the plurality of arithmetic operation devices. As a result, both the first and second arithmetic operation devices can resume the redundant process according to the updated program.

(4) The instruction issued by the update management device to the second arithmetic operation device includes an instruction for executing, before executing the updated program, a synchronization process to synchronize the updated program and a program being executed by the first arithmetic operation device with each other. As a result, for example, even in a case where the first and second arithmetic operation devices have different software configurations, it is possible to eliminate the risk that the output values become discrete at the timing of switching the execution programs and that an abnormality occurs in the control of the vehicle.

(5) The synchronization process includes (i) a process in which the second arithmetic operation device outputs a value obtained by recalculating, based on the updated program, a value output by the first arithmetic operation device, (ii) a process in which the second arithmetic operation device outputs the same value as a value output by the first arithmetic operation device, or (iii) a process in which the second arithmetic operation device outputs an initial value included in the updated program. As a result, it is possible to select an appropriate one of the above synchronization processes, depending on the nature of the update target program.

(6) A map and route information management device is further included. The update management device acquires map and route information from the map and route information management device and determines, based on a traveling state of the vehicle and the map and route information, whether the plurality of arithmetic operation devices are performing the redundant process. As a result, for example, by storing the traveling state of the vehicle such as an autonomous driving level in association with the map and route information, it is possible to automatically determine, by acquiring the map and route information, whether the redundant process is being performed.

(7) The update management device partially updates the programs stored in the first arithmetic operation device and the second arithmetic operation device. As a result, even when the first and second arithmetic operation devices partially have different hardware configurations or software configurations, it is possible to update, for example, only a common part, and the present invention can be more useful.

The technical scope of the present invention is not limited to the scope described in the above embodiments, and various modifications are included in the present invention without departing from the main features of the present invention. Therefore, the above-described embodiments are merely examples and should not be interpreted in a limited manner. In addition, a part of the configuration of each embodiment can be added, deleted, and replaced with another configuration, and all the modified configurations are within the scope of the present invention.

### REFERENCE SIGNS LIST

100, 500 update management system
101 first arithmetic operation device
102 second arithmetic operation device
103 vehicle control device (update management device)
501 map and route information management device

1. An update management system mounted on a vehicle, the update management system comprising:
a plurality of arithmetic operation devices; and an update management device that controls the plurality of arithmetic operation devices,
wherein the plurality of arithmetic operation devices include at least a first arithmetic operation device and a second arithmetic operation device, and
the update management device determines whether the second arithmetic operation device is executing a redundant process while the vehicle is traveling, and when determining that the second arithmetic operation device is not executing the redundant process, update management device restricts execution of the redundant process by the first arithmetic operation device and updates a program stored in the second arithmetic operation device.

2. The update management system according to claim 1,
wherein, when the update management device determines, after updating the program stored in the second arithmetic operation device, that the vehicle stops, the update management device instructs the second arithmetic operation device to execute the updated program and updates a program stored in the first arithmetic operation device.

3. The update management system according to claim 2,
wherein, when the update management device determines, after updating the program stored in the first arithmetic operation device, that the vehicle stops, the update management device instructs the first arithmetic operation device to execute the updated program and lifts the restriction of execution of the redundant process by the plurality of arithmetic operation devices.

4. The update management system according to claim 2,
wherein the instruction issued by the update management device to the second arithmetic operation device includes an instruction for executing, before executing the updated program, a synchronization process to synchronize the updated program and a program being executed by the first arithmetic operation device with each other.

5. The update management system according to claim 4,
wherein the synchronization process includes a process in which the second arithmetic operation device outputs a value obtained by recalculating, based on the updated program, a value output by the first arithmetic operation device.

6. The update management system according to claim 4,
wherein the synchronization process includes a process in which the second arithmetic operation device outputs a same value as a value output by the first arithmetic operation device.

7. The update management system according to claim 4,
wherein the synchronization process includes a process in which the second arithmetic operation device outputs an initial value included in the updated program.

8. The update management system according to claim 1, further comprising
a map and route information management device,
wherein the update management device acquires map and route information from the map and route information management device and determines, based on a traveling state of the vehicle and the map and route information, whether the plurality of arithmetic operation devices are performing the redundant process.

9. The update management system according to claim 1,
wherein the update management device partially updates the programs stored in the first arithmetic operation device and the second arithmetic operation device.
